(19) United States
(12) Patent Application Publication
(10) Pub. No.: US 2020/0122055 A1
(43) Pub. Date: Apr. 23, 2020

(54) PORTABLE APPARATUS FOR PRODUCING INFUSED OIL

(71) Applicant: David M. Tumey, Coral Springs, FL (US)

(72) Inventor: David M. Tumey, Coral Springs, FL (US)

(73) Assignee: Bluegrass Farmaceutucals, LLC, Belton, KY (US)

(21) Appl. No.: 16/655,462

(22) Filed: Oct. 17, 2019

Related U.S. Application Data
(60) Provisional application No. 62/747,214, filed on Oct. 18, 2018.

(51) Int. Cl. B01D 11/02; A23D 9/04; B01D 29/11

(52) U.S. Cl. CPC B01D 11/0288; G01F 11/284; B01D 29/11; A23D 9/04

(57) ABSTRACT

The present general inventive concept provides, for example, an oil infuser and metered dispenser for creating botanical extracts, and in particular cannabis-infused oil for use in consumable products such as foodstuffs. The dispenser comprises an infusing compartment and a filter disposed therein for receiving one or more botanical pods. A pump draws a base oil from a heated infusing compartment through the filter and botanical pods, and out the filter back into the infusing compartment. The oil continues circulating in this fashion until the concentration of the infusion reaches a desired level at which time the oil is pumped into a dispensing compartment. The filter prevents particulate matter from accumulating in the infused oil. A sensor is included for measuring predetermined amounts of infused oil. Flavored botanical pods are provided for infusing seasoning, herbs, and other flavors into the base oil in addition to cannabis floral material.

### FIELD OF THE INVENTION

The present general inventive concept relates to infused oils and more particularly, to a device for infusing a base oil with cannabis, seasonings, herbs, or other flavors, and dispensing the infused oil in metered quantities.

### BACKGROUND OF THE INVENTION

Infusion is well known and generally utilized with myriad botanicals, typically herbs, that dissolve readily in water, or, in the alternative, release their active ingredients easily in oil. Quantities of the herb/water or herb/oil mix will vary according to the type of herb utilized and/or how strong the infusion is required to be. A common mixing proportion used is approximately one ounce of herb to one pint of liquid. A common example is herbal tea. People often drink infusions of this type for pleasure; other times for health reasons. Herbal remedies and herb-infused oils can be likewise be prepared utilizing dried herbs, berries, or floral material, infused together with oil or water. The herb/botanical is then strained from the liquid and the liquid is subsequently used in preparations that require infused botanicals.

Infusion is often prepared by combining an infusion base liquid, for example, hemp seed oil, with an herb, and refrigerating the resulting infused oil. Infused oils may also be used for seasonings, like herbs and spices, which magnify a food's natural flavoring making it richer or more delicate, and other seasonings, like black pepper and basil, which transfer some of their flavor to the food.

More recently, a number of companies began offering in-home devices for the infusion of cannabis, and more particularly cannabinoids. These machines can be utilized to prepare cannabis oil infusions that are subsequently used to prepare consumable foodstuffs.

U.S. Pat. No. 7,213,507 describes an infusion beverage brewing system that includes a chamber and an infuser. The infuser is situated in a liquid, such as hot water, and has an infusing chamber for containing infusible materials, such as tea leaves or herbs. After a pre-determined brewing time has elapsed, the user moves a piston past a perforated wall portion of the infusing chamber, where small apertures prevent the passage of the tea leaves or other infusible material, isolating the infusible material from the liquid.

U.S. Pat. No. 6,726,946 allows a user to brew and store beverages such as tea. The device includes a base container for storing the loose tea leaves prior to brewing. An infuser element is removably attached to the base container. The infuser is manufactured so that that it may be inverted over a drinking container and receives a predetermined amount of fresh tea leaves to be soaked throughout the brewing process.

Oil infusion, particularly in the home, is typically accomplished with herbs and oils in a fenestrated container. However, this traditional method ends up dispensing not just the infused oil, but the unfiltered and undesirable particles that accumulate in the oils. Additionally, the infusion process is typically manual, which is far less precise and more difficult to repeat, and can easily create a mess.

### SUMMARY OF THE INVENTION

The present general inventive concept provides an oil infuser and metered dispenser for creating botanical extracts, and in particular cannabis-infused oil for use in consumable products such as foodstuffs. The dispenser comprises an infusing compartment and a removable filter disposed therein for receiving one or more botanical pods, each pod containing a particular desired botanical such as cannabis floral material, herbs, spices and the like. A fluid pump mechanism, for example, a gear pump, draws a base oil from a heated infusing compartment through the filter and botanical pods, and out the filter back into the infusing compartment. The oil continues circulating in this fashion until the concentration of the infusion reaches a desired level at which time the oil is pumped into a dispensing compartment through a sensor (e.g., automatic infrared dispenser). The filter prevents particulate matter from accumulating in the infused oil.

In one embodiment of the present general inventive concept, an infusion device comprises: a heated infusing compartment for holding a base oil at a predetermined temperature; a dispensing compartment for dispensing infused oil; a removable filter disposed inside the infusing compartment, wherein the removable filter is configured to hold one or more botanical pods; and a pump for drawing the base oil into the removable filter, through the one or more botanical pods, and out of the removable filter to create infused oil, and further drawing the infused oil into the dispensing compartment. The device may further comprise a meter for dispensing a predetermined amount of infused oil out of the dispensing compartment, tubing, and a transparent lid in the infusing compartment. The pump may be powered by a standard wall outlet, wall-mounted AC adapter or other suitable electrical power supply. The botanical pods may comprise cannabis, rosemary, chipotle, sage, garlic, seasoning, or herbs. The device may further comprise an adjuster mechanism for adjusting the predetermined amount of infused oil. The dispensing compartment may be see-through and infused oil may be dispensed in a drizzle, spray or stream.

In another embodiment of the present general inventive concept, an oil infusion system comprises: a portable countertop oil infusing device, and one or more botanical pods for infusing one or more phytoconstituents into a base oil via the portable countertop oil infusing device. The botanical pods may be specially adapted for use in a portable countertop oil infusing device.

In still another embodiment of the present general inventive concept, a device comprises: a heated infusing compartment comprising an electric heating element and pump, the infusing compartment configured to store a removable filter with a botanical pod inside and an infusion base liquid; and a dispensing compartment attached to the infusing compartment, the dispensing compartment comprising an adjuster mechanism, a sensor, and a dispensing outlet, wherein the pump draws the infusion base liquid through the botanical pod and the filter and the dispensing compartment dispenses a metered amount of an infused oil using the measuring mechanism, the sensor, and the dispensing outlet. The device may further comprise a meter for dispensing a predetermined amount of infused oil out of the dispensing compartment, tubing, and a clear lid in the infusing compartment. The botanical pods may comprise cannabis, rosemary, chipotle, sage, garlic, seasoning, or herbs. The device may further comprise an adjuster mechanism for adjusting the predetermined amount of infused oil. The dispensing compartment may be see-through and infused oil may be dispensed in a drizzle, spray or stream.

An advantage of the present general inventive concept is that it creates infused oils without the mess created by other known infusion devices. Another advantage of the present general inventive concept is that the infused oils are created in measurable quantities preventing a user from dispensing too much oil, as the amount of oil can be metered. Yet another advantage of the present general inventive concept is that it permits a user to create infused oils in-home thus eliminating the need to purchase expensive commercial infused oil. Even if the user already makes infused oil at home, the user will typically have to keep and store many bottles of oil (e.g., a dozen bottles) to have all the desired varieties on-hand, occupying significantly more kitchen storage space than required for the same amount of botanical pods. Further, the user has the ability to experiment with the various base oils to match any preferred taste or flavoring. Also, dispensing the infused oil is simple permitting the user to have, for example, a skillet in one hand and a spatula in the other while dispensing the infused oil in the skillet. Lastly, the user can make the oil on demand so it is fresh, as opposed to using potentially stale oil that was made at an earlier date.

An infusing apparatus, comprising:

Accordingly, an embodiment is directed to an infusing compartment having an electrically powered resistive heating element (preferably including an automatic temperature controller to maintain a thermal set-point) operably connected thereto configured to hold a predetermined amount of a fluid, a fluid circulator operably disposed to the infusing compartment for circulating said fluid, a filter zone disposed within the infusing compartment through which the fluid passes and for receiving an ingredient in which at least apart thereof is infused in the fluids to provide infused fluid, and a conduit operably connected to the infusing compartment for removing infused fluid therefrom. The fluid circulator can be an electrically actuated fluid pump with a variable speed controller. The pump can be operably connected to a conduit for pumping an amount of the infused fluid out the conduit.

The fluid is preferably an oil. The oil can be one of coconut oil, medium-chain triglyceride (MCT) oil, olive oil, palm oil, soybean oil, canola oil, pumpkin seed oil, corn oil, sunflower oil, safflower oil, peanut oil, grape seed oil, sesame oil, argan oil and rice bran oil.

Other features and advantages of the present general inventive concept will be apparent from the following, more particular description of the preferred embodiments of the present general inventive concept, the accompanying drawings, and the claims.

### BRIEF DESCRIPTION OF THE DRAWINGS

For a more complete understanding of the present general inventive concept, and the advantages thereof, reference is now made to the ensuing descriptions taken in connection with the accompanying drawings briefly described as follows:

FIG. 1 illustrates a cannabis oil infuser and metered dispenser according to an embodiment of the present general inventive concept;

FIG. 2 illustrates a fine mesh filter and different botanical pods for use in the oil infuser of FIG. 1; and

FIG. 3 illustrates the oil infuser of FIG. 1 with the filter placed inside an infusing compartment.

### DETAILED DESCRIPTION OF THE PREFERRED EMBODIMENT

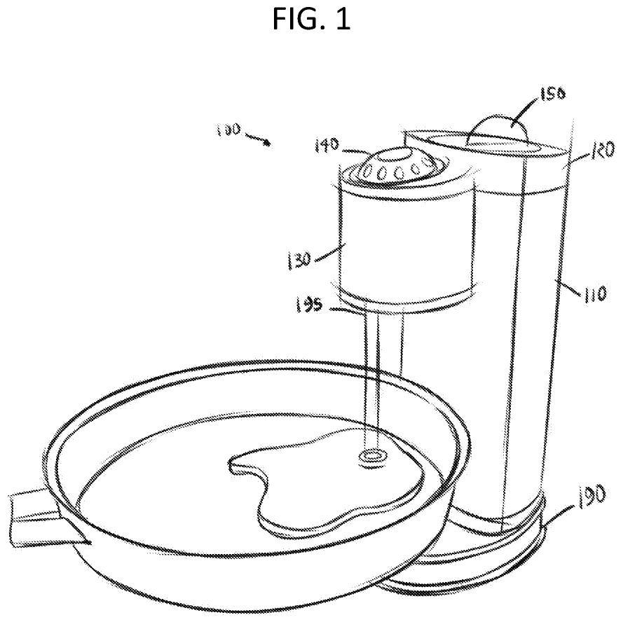

Further features and advantages of the present general inventive concept, as well as the structure and operation of various embodiments of the present general inventive concept, are described in detail below with reference to the accompanying FIGS. 1-3, wherein like reference numerals refer to like elements. Although the present general inventive concept is described in the context of a convenient home countertop appliance for infusing oil with botanicals, the present general inventive concept is applicable to other non-oil-based liquids, e.g., water that can be infused with substances, and may be increased in scale to accommodate larger commercial and industrial applications.

In one embodiment, the present general inventive concept provides an oil infuser and metered dispenser for botanical extracts, and in particular cannabis-infused oil for use in consumable products such as foodstuffs. The dispenser comprises an infusing compartment and a removable filter disposed therein for receiving one or more botanical pods. A pump draws a base oil from a heated infusing compartment through the filter and botanical pods, and out the filter back into the infusing compartment. The oil continues circulating in this fashion until the concentration of the infusion reaches a desired level at which time the oil is pumped into a dispensing compartment. The filter prevents particulate matter from accumulating in the infused oil. A sensor is included for measuring predetermined amounts of infused oil. Various botanical pods are provided for infusing seasoning, herbs, and other flavors into the base oil.

FIG. 1 illustrates a cannabis oil infuser and metered dispenser 100 according to an embodiment of the present general inventive concept. The oil infuser 100 comprises a housing 110 for enclosing the internal components of the infuser. In an exemplary configuration, the housing 110 includes a heated infusing compartment 120 utilizing an electrically powered resistive heating element well known to anyone of ordinary skill in the art, and a dispensing compartment 130. A dial-knob 140 (e.g., adjuster mechanism) is disposed on the dispensing compartment 130 and adjusts an amount of dispensed oil to a number of predetermined amounts through use of an internal automatic infrared sensor (not shown) to regulate quantity (e.g., 1 tablespoon, 2 tablespoons, 3 tablespoons, etc.). However, other types of sensors can be used to measure the dispensed liquid, the identification and implementation of which is apparent to one of ordinary skill in the art. The dispensing compartment 130 includes an outlet 195 (e.g., dispensing outlet) wherein the infused oil is dispensed into a suitable receptacle such as a pan as shown underneath the dispensing compartment 130. The infused oil can be dispensed in a drizzle, spray, stream or any other pattern. Other receptacles can include a container, vessel, skillet, bottle, glass, etc. In one embodiment, the infusing compartment 120 includes a transparent lid 150 (e.g., see thru lid) permitting a user to see inside the compartment when the lid is closed. The clear lid 150 allows the user to see the oil level and infusion concentration level (color of the oil), among other purposes, such as seeing if the infusing compartment 120 contains botanical pods. In another embodiment, the entire infusing compartment 120 is clear such that the user can easily see inside. A base 190 is where a power supply is housed. The power supply powers the heating element and the pump that circulates infused oil within infusing compartment 120 and subsequently out of the infusing compartment 120 into the dispensing compartment 130. One of ordinary skill in the art appreciates that the power supply can be replaced with a power adapter or other suitable means for receiving electrical energy from, for example, an electrical wall outlet.

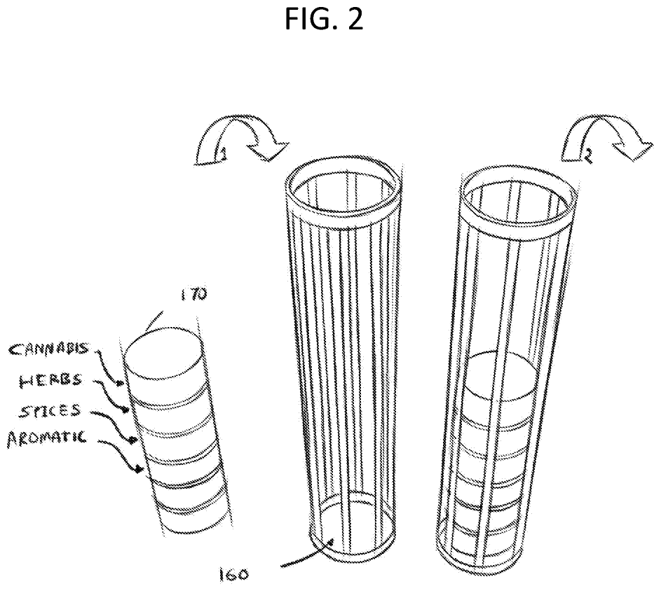

FIG. 2 illustrates a removable fine mesh filter 160 and different botanical pods 170 (e.g., cannabis, aromatic pods refills, favorite herbs, etc.) for use in the oil infuser 100. In operation, one or more botanical pods 170 are first inserted into the mesh filter 160, which is then placed inside the infusing compartment 120, which is subsequently filled with a base oil. A pump (not shown) draws the base oil into the mesh filter 160, then through the botanical pods 170 in order to infuse one or more phytoconstituents into the base oil, and then out through mesh filter 160 and back into the infusing compartment 120. The oil is circulated in this fashion until the concentration of the infusion reaches a desired level at which time the oil is pumped into the dispensing compartment 130. The mesh filter 160 prevents particulate matter in the pods 170 from accumulating in the infused oil.

The base oil can be any type of edible or cooking oil, which is preferably liquid at room temperature. Exemplary edible oils include, but are not limited to hemp seed oil, coconut oil, medium-chain triglyceride (MCT) oil, olive oil, palm oil, soybean oil, canola oil, pumpkin seed oil, corn oil, sunflower oil, safflower oil, peanut oil, grape seed oil, sesame oil, argan oil and rice bran oil. Many other kinds of vegetable oils are also used for cooking. In an embodiment of the present general inventive concept, the device 100 further comprises a heater (not shown) for decreasing the viscosity of the base oil, particularly in the case of saturated oils such as coconut oil.

Each botanical pod 170 may include one or more seasonings, flavors, or herbs. The pods can be herbs chosen by the user or herbs filled into manufactured tea bag like pouches, for example. Exemplary seasonings and herbs (or flavors) include, but are not limited to garlic, rosemary, chipotle, sage, salt, pepper, basil, chopped peppers, paprika, curry, cayenne, mixed spices, vinegar, orange, lemon, onion, chives, horseradish, mustard, capers, chilis, and any combination thereof.

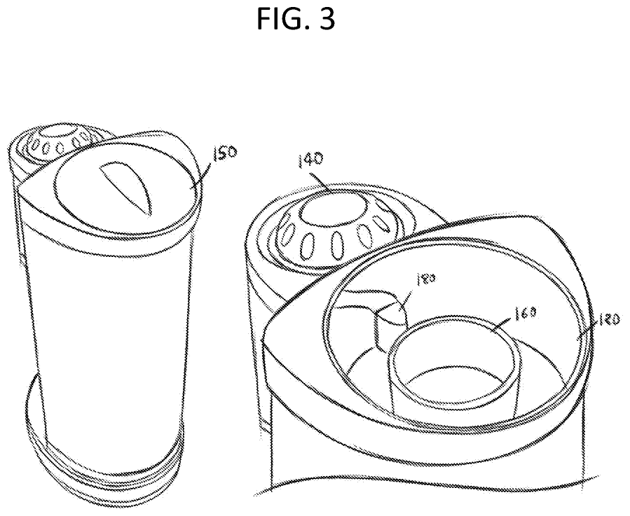

FIG. 3 illustrates the oil infuser 100 with the removable filter 160 placed inside the infusion compartment 120. Tubing 180 is coupled to the pump (not shown) and draws infused oil into the dispensing compartment 130. The dispensing compartment 130 includes a sensor (not shown), which can be an infrared beam or similar sensor, the identification and implementation of which are apparent to one of ordinary skill in the art. When the container is placed underneath the dispensing compartment 130, the pump is activated and will dispense a preset amount of infused oil. In an alternative embodiment of the present general inventive concept, the base of the device (in the area directly opposite to the dispensing compartment 130) could have an embedded pressure sensitive switch (not shown), the implementation of which is apparent to one of ordinary skill in the art. The pressure exercised onto the switch will activate the pump hence dispensing the infused oil.

In another embodiment of the present general inventive concept, the device 100 can be used for cosmetic purposes, e.g., to infuse oils and other liquids for massage, aroma therapy, skin and hair care with other aromatic substances such as hemp, herb and flowers.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, rather than sequentially.

The above described embodiments are set forth by way of example and are not for the purpose of limiting the scope of the present general inventive concept. It will be readily apparent that obvious modifications, derivations and variations can be made to the embodiments without departing from the scope of the present general inventive concept. Accordingly, the claims appended hereto should be read in their full scope including any such modifications, derivations and variations.

What is claimed is:

1. An infusing apparatus, comprising:
an infusing compartment having an electrically powered resistive heating element operably connected thereto configured to hold a predetermined amount of a fluid;
a fluid circulator operably disposed to said infusing compartment for circulating said fluid;
a filter zone disposed within said infusing compartment through which said fluid passes and for receiving an ingredient in which at least apart thereof is infused in said fluids to provide infused fluid; and
a conduit operably connected to said infusing compartment for removing infused fluid therefrom.

2. The infusing apparatus of claim 1, wherein said fluid circulator is an electrically actuated fluid pump.

3. The infusing apparatus of claim 2, wherein said fluid pump includes a variable speed controller.

4. The infusing apparatus of claim 1 which further includes a pump operably connected to said conduit for pumping an amount of said infused fluid out said conduit.

5. The infusing apparatus of claim 1, wherein said fluid is an oil.

6. The infusing apparatus of claim 5, wherein said oil is coconut oil.

7. The infusing apparatus of claim 5, wherein said oil is medium-chain triglyceride (MCT) oil.

8. The infusing apparatus of claim 1, which includes an infusion concentration sensor operably disposed in said infusion compartment for sensing ingredient infusion concentration in said fluid.

9. The infusing apparatus of claim 1, which includes a timer operably disposed to cause cessation of fluid circulation after a predetermined interval.

10. The infusing apparatus of claim 1, wherein said electrically powered resistive heating element includes an automatic temperature controller to maintain a thermal set-point.

11. The infusing apparatus of claim 4, wherein said pump is operably connected to said conduit for pumping an amount of said infused fluid out said conduit upon reaching a predetermined sensed concentration threshold.

12. The infusing apparatus of claim 8, wherein said sensor is an automatic infrared sensor.

13. The infusing apparatus of claim 1, wherein said filter zone is equipped to removably receive at least one filter pod having said ingredient therein.

14. The infusing apparatus of claim 13, wherein said pod includes a botanical pod containing a predetermined botanical.

15. The infusing apparatus of claim 14, wherein said botanical includes one of a cannabis floral material, an herb, and a spice.

16. The infusing apparatus of claim 5, wherein said oil is one of coconut oil, medium-chain triglyceride (MCT) oil, olive oil, palm oil, soybean oil, canola oil, pumpkin seed oil, corn oil, sunflower oil, safflower oil, peanut oil, grape seed oil, sesame oil, argan oil and rice bran oil.
